(19) United States
(12) Patent Application Publication
(10) Pub. No.: US 2013/0086680 A1
(43) Pub. Date: Apr. 4, 2013

(54) SYSTEM AND METHOD FOR COMMUNICATION IN A NETWORK

(71) Applicants: John Erik Hershey, Ballston Lake, NY (US); Bruce Gordon Barnett, Troy, NY (US); Michael Joseph Dell'Anno, Clifton Park, NY (US); Daniel Thanos, Stouffville (CA)

(72) Inventors: John Erik Hershey, Ballston Lake, NY (US); Bruce Gordon Barnett, Troy, NY (US); Michael Joseph Dell'Anno, Clifton Park, NY (US); Daniel Thanos, Stouffville (CA)

(73) Assignee: GENERAL ELECTRIC COMPANY, Schenectady, NY (US)

(21) Appl. No.: 13/249,368

(22) Filed: Sep. 30, 2011

(51) Int. Cl. G06F 21/00

(52) U.S. Cl. 726/23

(57) ABSTRACT

A method for providing secure communication in an electrical power distribution network includes detecting an enhanced threat level in the electrical power distribution network. A threshold number of different configuration command shadows are received and processed to generate a configuration command data. A verified configuration command data is generated by comparing the configuration command data with a stored configuration commands and a verified configuration command related to the verified configuration command data is executed.

### BACKGROUND

Embodiments of the present invention relate generally to power utility networks. More specifically, the embodiments relate to a system and method of communicating secure messages over networked systems in a power utility network.

A modern society is served by utilities that must function properly at almost all times. Proper functioning is typically expressed by reliability, availability, accountability, and certifiability, the latter term meaning the ability of a user of a utility to actively query and learn the status of the utility. In order to meet growing demands while providing reliability and efficiency, utilities, such as electric utilities, are developing and implementing technologies to create an intelligent infrastructure, such as a “smart grid” infrastructure of the power grid.

In order to realize an intelligent infrastructure, the Federal Energy Regulatory Commission (FERC), the federal entity partly responsible for oversight of interstate sales of electricity and wholesale rates of electricity, and a successor to the Federal Power Commission, has specified four priorities for the Smart Grid: (1) Cybersecurity, (2) Intersystem Communications, (3) Wide area situational awareness, and (4) Coordination of the bulk power system. FERC's first priority, cybersecurity, is motivated by recognition of the ever-increasing emergence of cyber threats. The insinuation of malware, either through accident or design, has become commonplace. The effects of digital malware vary and the effects on the overall network's health and efficiency range from nuisance to severely minacious. The spectrum of the cyber malefactor's intentions is also expanding from simple to sophisticated hacking and includes physical attacks that may damage, delay, or disable routine and proper functioning of the grid. It is worrisome but prudent to expect that cyber malefactors may eventually expand to practicing coordinated cyber terrorism.

In order to limit the potential damage of the cyber security threat, efforts are underway to enable awareness of potential threat events as well as their details and effects in order to harden the utility communication infrastructure both proactively and in response to incidents.

For these and other reasons, there is a need for the present invention.

### BRIEF DESCRIPTION

In accordance with an embodiment of the present invention, a method for providing secure communications in an electrical power distribution network is provided. The method includes detecting an enhanced threat level in the electrical power distribution network and receiving a threshold number of different configuration command shadows. The method further includes processing the threshold number of different configuration shadows to generate a configuration command data and generating a verified configuration command data by comparing the configuration command data with a stored configuration commands. The method also includes executing a verified configuration command related to the verified configuration command data.

In accordance with another embodiment of the present invention, a communication system for an electrical power distribution network is provided. The communication system includes a threat response module for detecting an enhanced threat level in the electrical power distribution network and a plurality of control centers for transmitting a threshold number of different configuration command shadows to a host device. The host device is configured to process the threshold number of different configuration command shadows to generate a configuration command data and generate a verified configuration command data by comparing the configuration command data with a stored configuration commands. The host device is further configured to execute a verified configuration command related to the verified configuration command data.

In accordance with yet another embodiment of the present invention, an apparatus for providing secure communications is provided. The apparatus includes at least one memory that stored computer executable instructions and at least one processor configured to access the at least one memory. The at least one processor is configured to execute the computer executable instructions of detecting an enhanced threat level in an electrical power distribution network and receiving a threshold number of different configuration command shadows. The computer executable instructions further include processing the threshold number of different configuration command shadows to generate a configuration command data, generating a verified configuration command data by comparing the configuration command data with a stored configuration commands and executing a verified configuration command related to the verified configuration command data.

### DRAWINGS

These and other features, aspects, and advantages of the present invention will become better understood when the following detailed description is read with reference to the accompanying drawings in which like characters represent like parts throughout the drawings, wherein:

FIG. 1 is an electrical power distribution network in accordance with an embodiment of the present invention;

FIG. 2 is an example network illustrating a communication between control centers and a host device under an enhanced threat level in accordance with an embodiment of the present invention; and

FIG. 3 is a flowchart representing a method for providing secure communications in an electrical power distribution network in accordance with an embodiment of the present invention.

### DETAILED DESCRIPTION

As used herein, the term “module” refers to software, hardware, or firmware, or any combination of these, or any system, process, or functionality that performs or facilitates the processes described herein.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

In a power utility network, utility meters are important components to provide important information to the customer as well as the utility. As meter and communication technology have advanced, it has become possible to remotely read the utility meters. In addition, it has also become possible for utilities to remotely control meters. Such remote control includes remotely turning off a particular subscriber's power, for example. As the power grid becomes “smarter” with advancing technologies, communication between grid devices, customers, and the utilities will increase. As with any communication network, there is a danger that the grid or network will be vulnerable to cyber-attacks.

The embodiments described herein are directed to secure message communication in a network of power grid devices when an enhanced threat level is detected. While embodiments of the invention will be described in the context of energy or electric utility networks, it will be appreciated by those skilled in the art that the method and system can be used for other types of networks as well.

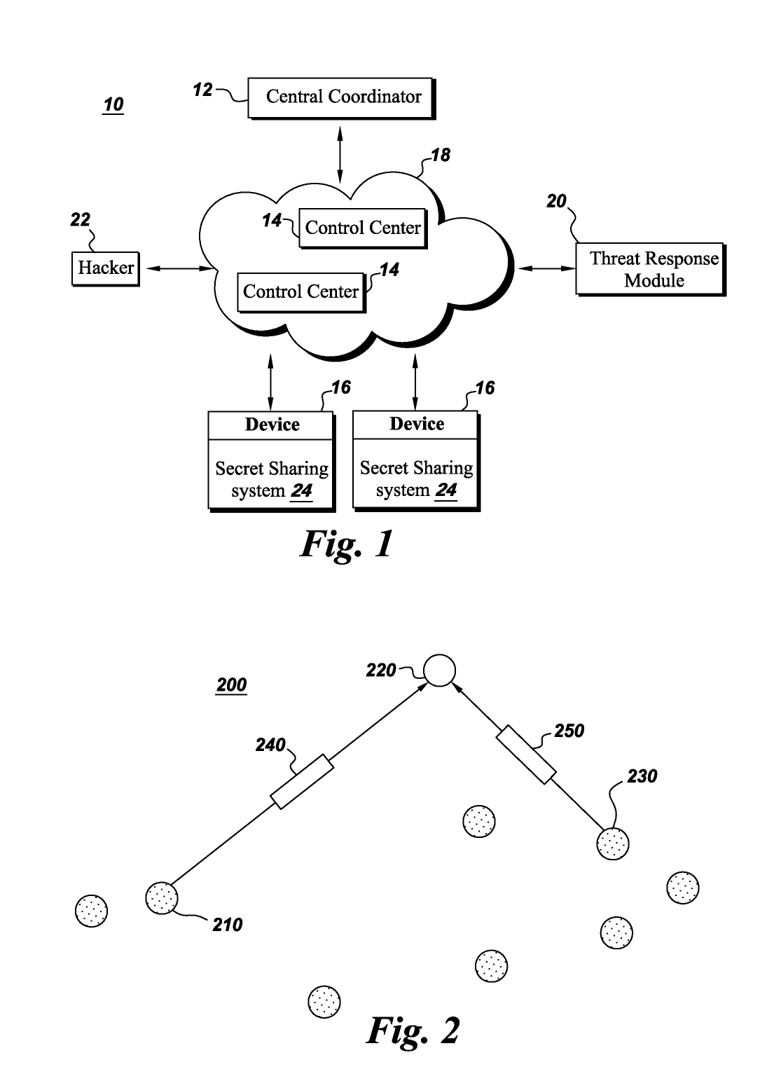

FIG. 1 shows an electrical power distribution network 10 in accordance with an embodiment of the present invention. Electrical power distribution network 10 includes a central coordinator 12 coupled to control centers 14 and host devices 16 via a network 18. A threat response module 20 is coupled to network 18 and communicates directly with all of the control centers 14, central coordinator 12, and host devices 16. In one embodiment, threat response module 20 may be located at the same place as central coordinator 12 or host devices 16 or control centers 14 and it stores various programs, including programs for monitoring and testing the network, for example. In order to facilitate the description of the embodiments of the invention, a single threat response module 20, a single central coordinator 12, and a small number of control centers 14 and host devices 16 are shown in FIG. 1. However, it should be understood that embodiments of the invention are not limited to these numbers, and that there can be any number of threat response modules 20, central coordinators 12, control centers 14, and host devices 16 in the network.

In the example discussed herein, central coordinator 12 which is used for system monitoring, demand managing, and operation optimizing can be arranged at and/or hosted by a utility or by any other party. Some implementations may have multiple central coordinators that operate in parallel, and some implementations will have communication between central coordinators.

In one embodiment, control centers 14 may be located at local management offices, distribution substations or transmission substations (not shown). During normal operation, control centers 14 send configuration command signals to host devices 16 based on communication with coordinator 12 for performing some actions or receiving some data from host devices 16. The configuration command signals instruct a host device as to what action to perform and how to perform the action i.e., the steps of performing the action. During an enhanced threat, control centers 14 send configuration command shadows to host device 16 which are processed by host devices to generate the configuration command. In general, configuration command shadows include part of the information needed to reconstruct the original configuration command. The details of configuration command shadows and their processing is described in following paragraphs. Each of the control centers 14 may include processing circuitry for processing data and communication elements such as transmitters and receivers for transmitting and receiving data. Control centers 14 may further forward the aggregated data from all host devices 16 to coordinator 12 for system monitoring, demand managing, and operation optimizing.

The network 18 may be wired, or wireless using such communications as the ZigBee, WiFi, WiMAX, HomePlug architectures, or a hybrid architecture comprising wired and wireless components. Communications between the host devices 16, control centers 14, threat response module 20, and the coordinator 12 include alerts or alarms for security breach, and infrastructure directives such as turning off or on a device.

At times, an individual or computer attempting to obtain unauthorized entry (Hacker 22) may intercept the messages sent over network 18, and thereby obtain all necessary information to gain full access to command sites 14 and host devices 16. In an embodiment, hackers might also be control center 14 that has been penetrated or otherwise gone rogue. Hackers may also be able to trick host devices into believing they are an authorized control center by exploiting known weaknesses in the overall network or gaining back door entry to the network.

Threat response module 20 includes active or passive programs to probe the network 18 for vulnerability to cyber threats from hacker 22. In one embodiment, threat response module 20 stores known threats and their properties in its data store and when such properties are detected, threat response module 20 detects the cyber threat. In another embodiment, threat response module 20 detects anomalies in configuration command signals to identify the cyber threat.

More particularly, when threat response module 20 detects a cyber-attack on network 18, it sends out an enhanced threat level communication to control center 14 and host devices 16. The enhanced threat level communication may be an alert or a control message indicating the actions to be performed under the enhanced threat level. For example, if there is evidence of a penetration, compromise, or co-option of an individual control center 14, there is a significant and dangerous possibility that such control center 14 may be attempting to subvert the proper functioning of the power utility by issuing deleterious configuration commands. Under this condition the power utility is operated under an enhanced threat level and threat response module 20 sends out control messages to control centers 14 and host devices 16.

In an exemplary embodiment, host devices 16 are utility meters associated with utility customers. In other embodiments, the host devices 16 may be relays, reclosers, line switches, and capacitor banks. Host devices 16 can also include one or more honeypots i.e., a trap set to detect, deflect, or in some manner counteract attempts at unauthorized use of information systems. Host devices 16 can be any host device found in a network environment and include a secret sharing system 24. Secret sharing system 24 is a software module for constructing a data related to a configuration command such as its serial number in a data store of host device 16 or a particular time at which the configuration command needs to be executed by processing configuration command shadows received from different control centers 14. Configuration command shadows are random configuration commands which are similar to original configuration commands but not an exact copy of it. For example, in simple terms, if the configuration command is to turn off a washing machine, then one configuration command shadow may just include the apparatus information i.e., ‘washing machine’ whereas the second configuration command shadow may include the action information, i.e., ‘turn off’. In other words, configuration command shadows do include some information or part of the information to reconstruct the original configuration command but they are not the original configuration command itself. The original configuration command can be retrieved only from a threshold number of different configuration command shadows. The threshold number may be determined by threat response module 20 or control centers 14 or host devices 16 and communicated to each other or is known a priori.

The construction of the configuration command shadow depends on the original configuration command data and also the threshold number. For example, if the threshold number is two and in binary terms, if 101 is the original configuration command data pointing to a configuration command to switch off a device, then the configuration command shadows may be 100 or 111 or 000. Any two of these configuration command shadows may then be processed to get the original configuration command data 101. Further, the configuration command shadows may change depending on the threshold number.

In an embodiment, if the threshold number of configuration command shadows to retrieve the original configuration command is t and secret sharing system 24 receives configuration command shadows from T control centers then secret sharing system 24 can retrieve the original configuration command data from configuration command shadow of any t of the T control centers. It should also be noted that configuration command shadows from any (t−1) control centers will not be sufficient to recreate the original configuration command data. Further, in one embodiment, processing the threshold number of configuration command shadows may include utilizing Boolean algebra or any other means such as finite field math.

Host devices 16 also include a data store (not shown) of configuration commands which need to be executed during an enhanced threat level. The data store may be updated regularly depending on the overall system changes. Once secret sharing system 24 retrieves the original configuration command data from any t of the T configuration command shadows, processing circuitry in host devices compares the retrieved configuration command data with the configuration commands already present in its data store. If any of the configuration commands in its data store matches with the retrieved configuration command data then only host device 16 acts on the configuration command.

As an example, consider that the original configuration command data related to the configuration command that needs to be executed includes two bits (k₁,k₂). For this example, assume there are a total of three control centers, i.e., T=3, and that any two of the three control centers are to be able to reconstitute the original configuration command bits, i.e., t=2. Now let's assume the first configuration command shadow has two random bits (r₁,r₂), a second configuration command shadow is (k₁⊕k₂⊕r₁,k₂⊕r₂) and a third configuration command shadow is (k₂⊕r₁,k₁⊕r₂), where ⊕ is modulo 2 addition, i.e., A⊕B=A B̅+BĀ in Boolean algebra terms or simply 0⊕0=1⊕1=0 and 0⊕1=1⊕0=1.

From the above construction, it is clear that the knowledge of only an individual shadow is of no advantage in solving for the original configuration command. The original configuration command bits, (k₁,k₂), may be recovered by secret sharing system 24 by using the shadows of the first and second control centers by first adding their second bits together to determine k₂ and then adding k₂ to the sum of their first bits yielding k₁.

Secret sharing system 24 may also recover the original configuration command bits by using the shadows of the first and third control centers by adding their first bits together to determine k₂ and then adding their second bits together to recover k₁ and then interchanging the bits position to recover original configuration command bits (k₁,k₂).

Secret sharing system 24 may further recover the original configuration command bits (k₁,k₂) using the shadows of the second and third control centers by adding their first bits together to determine k₁ and then adding k₁ to the sum of their second bits thereby recovering k₂.

It should also be noted that in all logic described above, the addition discussed is modulo 2 (exclusive-OR) addition and further that secret sharing system 24 will have different logic stored in its data store for different combinations of configuration command shadows received from control centers. For example, in the above case three different logic relations were used to retrieve the original configuration command from three different combinations of configuration commands received from three control centers. Once the bits (k₁,k₂) related to the configuration command data are retrieved, host device 16 will check whether any of the configuration commands in its data store matches with that configuration command data or the related bits and if it matches, then host device 16 will act on configuration command related to that data.

In one embodiment, the control message sent by threat response module 20 to control centers 14 may indicate that the control center 14 should generate the t number of configuration command shadows which will be processed by host devices 16 to determine a verified configuration command under the enhanced threat level. Control centers 14 then generate the t different configuration command shadows stored in their data store or receive it directly from threat response module 20 in coordination with central coordinator 12. In another embodiment, the control message sent from threat response module 20 to host devices 16 includes various logic for generating configuration command data from any t threshold number of shadows. Examples of such logic include Boolean algebra functions or any other type of logic such as finite field math. Host devices 16 then process the configuration command shadows to generate the configuration command data and execute the verified configuration command as described above.

In yet another embodiment, the threshold number for different configuration command shadows is decided a priori and is stored in data stores of control centers 14 and host devices 16. When the enhanced threat level alert is received from threat response module 20, control centers 14 send the configuration command shadows to host devices 16. Thus, in these embodiments, threat response module 20 only determines the enhanced threat level and issues a control message indicating a presence of the enhanced threat.

FIG. 2 illustrates an example network 200 illustrating a communication between control centers and a host device under an enhanced threat level. Network 200 depicts two control centers 210 and 230 and a host device 220. When the enhanced threat level is detected, threat response module 20 (FIG. 1) issues control messages including an enhanced threat alert to host device 220 and control centers 210 and 230. For the purpose of example, assume that the configuration command is reducing generator speed and the related configuration command data is 1-1-0. Control centers 210 and 230 then send configuration command messages 240 and 250 respectively to host device 220. Configuration command messages 240 and 250 include two different configuration command shadows 1-0-0 and 0-1-0. Host device 220 uses the shadows from control centers 210 and 230 and applies a logical ‘OR’ function to those shadows and develops the configuration command data. Further, host device 220 compares the developed configuration command data to the commands in its data store. If the developed configuration command data 1-1-0 matches with any command in its data store, host device 220 executes the related configuration command i.e., reducing generator speed.

In this example, the threshold number of control centers is 2, thus, only control centers 210 and 230 take part in communication and other control centers are not involved. Furthermore, if a hacker tries to send deleterious command to host device 220, it won't be acted on by host device 220 as it will not match the threshold number shadows i.e., 2. Also even if two hackers try to send deleterious command to host device 220, it will not be recognized by host device 220 as it will not be there in its data store.

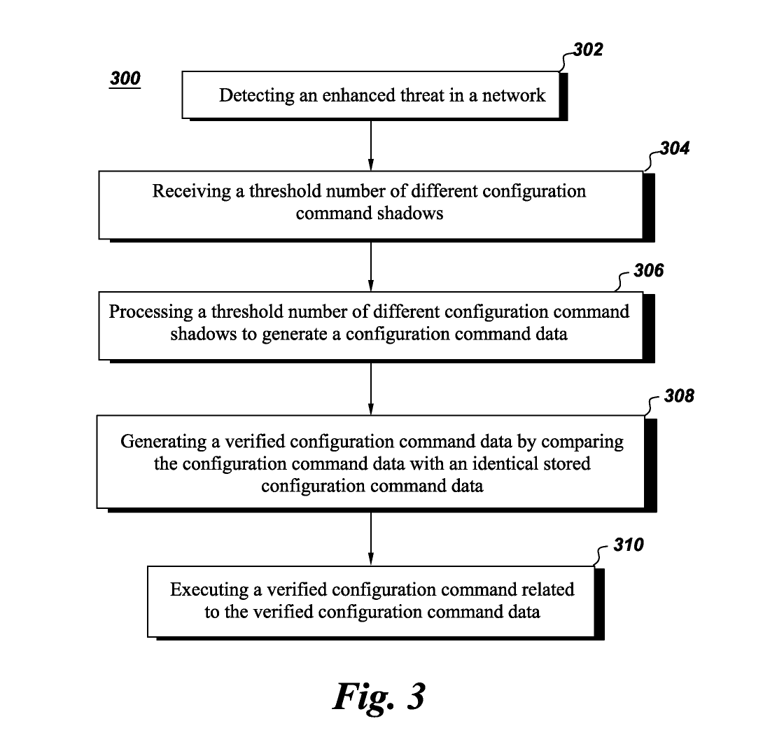

FIG. 3 shows a flowchart 300 representing a method for providing secure communications in an electrical power distribution network in accordance with an embodiment of the present invention. The method includes detecting an enhanced threat in a network at step 302. The enhanced threat may be detected by programs which monitor and test the network and sends an alert when any network security breach is observed.

When the enhanced threat level is detected, a threshold number of different configuration command shadows are received by host devices 16 (FIG. 1) at step 304. The configuration command shadows are generated by control centers 14. At step 306, the threshold number of different configuration command shadows are processed by host devices to generate a configuration command data. In one embodiment, the processing of different configuration command shadows may include utilizing Boolean algebra. In another embodiment, the threshold number for different configuration command shadows may be determined apriori and stored in the memory of control centers 14 or host devices 16. In other embodiments, threat response module 20 determines the threshold number for different configuration commands when a threat is detected and communicates the same to host devices and control centers. Threat response module 20 may further instruct control centers to either generate the related configuration command shadows by coordinating among themselves or may provide the configuration command shadows directly to control centers in coordination with central coordinator 12.

In step 308, the host devices compare the configuration command data generated in step 306 with configuration commands stored in its data store for generating a verified configuration command data. A verified configuration command related to the verified configuration command data is then executed by host devices in step 310. The configuration command may include performing an action such as reconfiguring a network by turning off one set of reclosers and by switching on another set of reclosers or turning off a particular subscriber's power.

While some exemplary embodiments of the invention have been described in the context of an electric power network, it will be appreciated by those skilled in the art that the method and system can be used in any communications network.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for providing secure communications in an electrical power distribution network, the method comprising:
detecting an enhanced threat level in the electrical power distribution network;
receiving a threshold number of different configuration command shadows at a host device;
processing the threshold number of different configuration command shadows to generate a configuration command data based on a combination of the threshold number of different configuration command shadows;
setting a stored configuration command data as a verified configuration command data if the configuration command data matches with the stored configuration command data; and
executing a verified configuration command related to the verified configuration command data.

2. The method of claim 1, wherein detecting the enhanced threat level comprises monitoring or testing or monitoring and testing the electrical power distribution network for a hacker attack.

3. The method of claim 1, wherein each of the threshold number of different configuration command shadows include information related to a reconstruction of the verified configuration command.

4. The method of claim 1, wherein the threshold number for different configuration commands is determined a priori.

5. The method of claim 1, wherein the threshold number for different configuration commands is determined by a threat response module or the command sites or the host device.

6. The method of claim 1, wherein processing the threshold number of different configuration command shadows includes utilizing Boolean algebra.

7. The method of claim 1, wherein processing the threshold number of different configuration command shadows includes utilizing different logics for the threshold number of different combinations of configuration command shadows.

8. The method of claim 1 wherein the verified configuration command includes an action to be performed and steps of performing the action.

9. A communication system for an electrical power distribution network, comprising:
a threat response module for detecting an enhanced threat level in the electrical power distribution network;
a plurality of control centers for transmitting a threshold number of different configuration command shadows to a host device;
wherein the host device is configured to:
process the threshold number of different configuration command shadows to generate a configuration command data which is a combination of the threshold number of different configuration command shadows;
set a stored configuration command data as a verified configuration command data if the configuration command data matches with the stored configuration command data; and
execute a verified configuration command related to the verified configuration command data.

10. The communication system of claim 9, wherein the host device comprises utility meters associated with utility customers, relays, reclosers, line switches, capacitor banks or honeypots.

11. The communication system of claim 9, wherein the threat response module includes active or passive programs to probe the electrical power distribution network for vulnerability to cyber threats from hacker.

12. The communication system of claim 9, wherein the threat response module works with a central coordinator to generate the threshold number of different configuration command shadows.

13. The communication system of claim 9, wherein each of the threshold number of different configuration command shadows include information related to reconstruction of the verified configuration command.

14. The communication system of claim 9, wherein the threshold number of different configuration commands is determined a priori.

15. The communication system of claim 9, wherein the threshold number of different configuration commands is determined by the threat response module or the command sites or the host device.

16. The communication system of claim 9, wherein the host device utilizes Boolean algebra to process the threshold number of different configuration command shadows.

17. The communication system of claim 9, wherein the host device utilizes different algorithms for the threshold number of different configuration command shadows received from different control centers.

18. An apparatus for providing secure communications, the apparatus comprising:
at least one memory that stores computer-executable instructions; and
at least one processor configured to access the at least one memory, wherein the at least one processor is configured to execute the computer-executable instructions to:
detect an enhanced threat level in an electrical power distribution network;
receive a threshold number of different configuration command shadows;
process the threshold number of different configuration command shadows to generate a configuration command data based on a combination of the threshold number of different configuration command shadows;
set a stored configuration command data as a verified configuration command data if the configuration command data matches with the stored configuration command data; and
execute a verified configuration command related to the verified configuration command data.
